(19) United States
(12) Patent Application Publication
(10) Pub. No.: US 2006/0228202 A1
(43) Pub. Date: Oct. 12, 2006

(54) System and method for hauling vehicles on a truck and setting up a tent

(76) Inventor: Jerry Johnson, Baker City, OR (US)

Correspondence Address: PEDERSEN & COMPANY, PLLC, P.O. BOX 2666, BOISE, ID, 83701, US

(21) Appl. No.: 11/103,837

(22) Filed: Apr. 11, 2005

(51) Int. Cl. B60P 1/43

(52) U.S. Cl. 414/538

(57) ABSTRACT

A platform for hauling small vehicles such as snowmobiles or four-wheelers on a pickup truck is disclosed. The platform is pulled onto the pickup truck bed by a winch and cable, and has rails which slide onto tracks mounted on the bed. The platform has elongated bins on opposite sides. The bins store a ladder, inclined bars for mounting the platform, and poles for erecting a tent. The platform serves as the base for a tent when removed from the truck.

### BACKGROUND OF THE INVENTION

1. Field of the Invention

The present invention relates to systems and methods for hauling small vehicles on a truck and setting up tents.

2. Related Art

Pickup trucks comprise a bed with sides extending longitudinally along the left and right edge of the bed. The bed is generally used to transport articles, and the sides serve to keep the articles from falling off of the bed.

Small vehicles such as four-wheelers or snowmobiles are often ridden by outdoor enthusiasts. However, these vehicles lack storage capacity. Thus, persons who desire to go camping cannot rely on these vehicles to both transport them to the desired spot and carry needed supplies to the desired spot.

Outdoor enthusiasts enjoy camping under shelter of tents. However, tents are large and cumbersome, and cannot be transported with a four-wheeler or snowmobile.

### SUMMARY OF THE INVENTION

The present invention is a platform for carrying vehicles on a truck. The platform slides on and off of the bed of the truck, and is configured to have a ladder attach to the platform for the purpose of loading and unloading the vehicles from the platform. The platform also serves as the base for a tent after it is removed from the truck.

### BRIEF DESCRIPTION OF THE DRAWINGS

The accompanying drawings illustrate several aspects of embodiments of the present invention. The drawings are for the purpose only of illustrating preferred embodiments of the invention, and are not to be construed as limiting the invention.

FIG. 1 is a perspective view of an embodiment of the present invention being used for hauling snowmobiles.

FIG. 2 is a perspective view of an embodiment of the present invention being used for hauling four-wheelers.

FIG. 3 is a top view showing the platform being removed from the truck in an embodiment of the present invention.

FIG. 4 is a bottom perspective view showing the platform being removed from the truck in an embodiment of the present invention.

FIG. 5 is a blown-up section of FIG. 4 showing the means of attachment between the winch cable and the platform in an embodiment of the present invention.

FIG. 6 shows a truck with tracks and a pair of track extensions which are used to install the platform onto the truck in an embodiment of the present invention.

FIG. 7 is a blown-up section of FIG. 6 showing the track attachment piece connecting the tracks to the track extensions, as well as the switching unit for controlling the winch, in an embodiment of the present invention.

FIG. 8 shows the pair of track extensions used for installing the platform onto the truck and their means of attachment to the intermediate support member in an embodiment of the present invention.

FIG. 9 shows the tracks and the winch attached to the truck in an embodiment of the present invention.

FIG. 10 is a blown-up section of FIG. 9 showing the front end of a track and the track attachment piece after the track attachment piece has been moved forward and out of use in an embodiment of the present invention.

FIG. 11 is a blown-up section of FIG. 9 showing the winch in an embodiment of the present invention.

FIG. 12 is a blown-up section of FIG. 9 showing the rear end of a track with the track attachment piece after the track attachment piece has been moved into position to connect to the track extension in an embodiment of the present invention.

FIG. 13 is a side view of a truck with the platform attached in an embodiment of the present invention.

FIG. 14 is a blown-up section of FIG. 13 showing the cab guard of an embodiment of the present invention.

FIG. 15A is a top perspective view of the platform of an embodiment of the present invention.

FIG. 15B is an exploded view of the frame of the platform in an embodiment of the present invention.

FIG. 15C shows a cross-section of the center piece of the frame in an embodiment of the present invention.

FIG. 15D shows a cross-section of the perimeter of the frame in an embodiment of the present invention.

FIG. 16 is a blown-up section of FIG. 15A showing the rear door open on the rear end of a bin on the platform of an embodiment of the present invention.

FIG. 17 is a blown-up section of FIG. 15A showing the side door open on the side of a bin on the platform of an embodiment of the present invention.

FIG. 18 is a bottom perspective view of the platform in an embodiment of the present invention.

FIG. 19 is a blown-up section of FIG. 18 showing the attachment of the hook on the cable of the winch to the platform of the present invention.

FIG. 20 is a blown-up section of FIG. 18 showing the rail that slides into the track of an embodiment of the present invention.

FIG. 21 is a bottom view of the platform in an embodiment of the present invention.

FIG. 22 is a front view of the platform in an embodiment of the present invention.

FIG. 23 is a perspective view of the intermediate support member after it has been locked into place and ready to support the pair of track extensions in an embodiment of the present invention.

FIG. 24 is a perspective view of the intermediate support member before the cross bar has been attached in an embodiment of the present invention.

FIG. 25 is a perspective view of the intermediate support member after it has been folded and prepared for storage in an embodiment of the present invention.

FIG. 26 is a perspective view of the ladder in an embodiment of the present invention.

FIG. 27 is a blown-up section of FIG. 26 showing the means of connection between the crosspieces and the sidepieces and between the sidepieces and a ladder attachment piece in an embodiment of the present invention.

FIG. 28 is a bottom perspective view of a ladder attachment piece in an embodiment of the present invention.

FIG. 29 is a perspective view of a sidepiece after it has been extended and set into place for use in an embodiment of the present invention.

FIG. 30 is a perspective view of a sidepiece as it is being extended into place for use in an embodiment of the present invention.

FIG. 31 is a perspective view of a sidepiece after it has been folded for storage in an embodiment of the present invention.

FIG. 32 is an exploded view of a track, cab guard, and cab guard supports of an embodiment of the present invention.

FIG. 33 is a perspective view of a track in an embodiment of the present invention.

FIG. 34 is a front view of a track in an embodiment of the present invention.

FIG. 35 is a bottom perspective view of a track attachment piece which attaches to a track and a track extension in an embodiment of the present invention.

FIG. 36 shows the tent structure built around the platform without the flaps or panels in an embodiment of the present invention.

FIG. 37 is a blown-up section of FIG. 36 showing a five-way connector for a tent structure in an embodiment of the present invention.

FIG. 38 is a blown-up section of FIG. 36 showing an adjustable base piece for a tent structure in an embodiment of the present invention.

FIG. 39 is a partially exploded view of the portion of the tent structure without the flaps or panels which is built above the platform in an embodiment of the present invention.

FIG. 40 is a bottom perspective view of a portion of a tent structure built around the platform in an embodiment of the present invention.

FIG. 41 is a blown-up section of FIG. 40 showing the connection between two panels in an embodiment of the present invention.

FIG. 42 is a blown-up section of FIG. 40 showing the connection between the platform and a panel in an embodiment of the present invention.

FIG. 43 is a top perspective view of a tent with panels attached in an embodiment of the present invention.

FIG. 44 is a top perspective view of a set of end panels of the tent in an embodiment of the present invention.

FIG. 45 shows various connectors for building the tent in an embodiment of the present invention.

FIG. 46 is a top view of a three-way connector of an embodiment of the present invention.

FIG. 47 shows poles, including an adjustable base piece and an adjustable pole, for a tent structure of an embodiment of the present invention.

### DESCRIPTION OF THE PREFERRED EMBODIMENTS

The preferred embodiment of the invented platform system 5 is used to load small vehicles, such as four-wheelers 8 or snowmobiles 6, onto a platform 40 on a truck 4, transport them to a campsite, unload the vehicles from the truck 4, unload the platform 40 from the truck, and use the platform 40 as the base for a camp or tent.

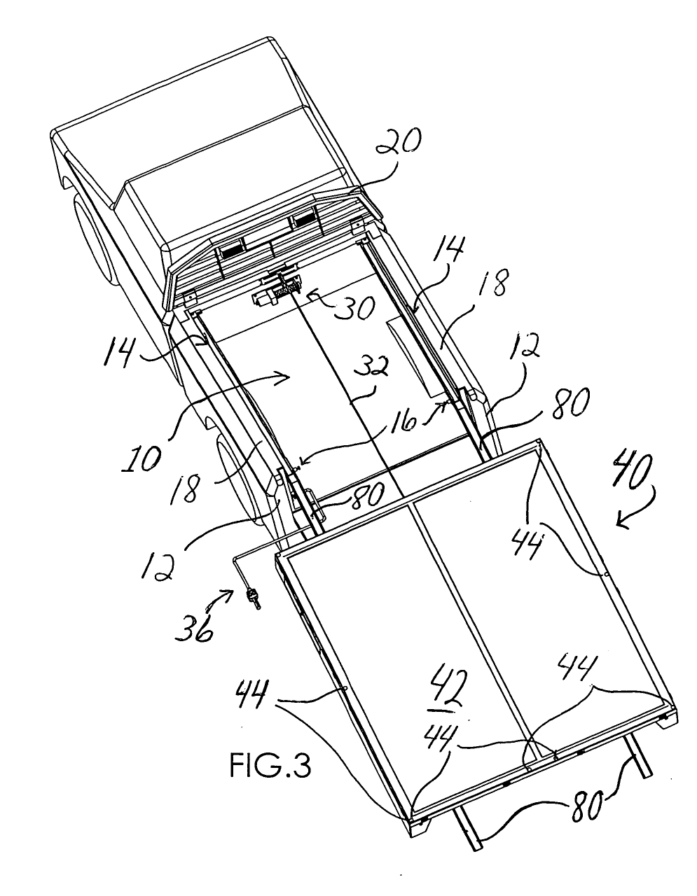

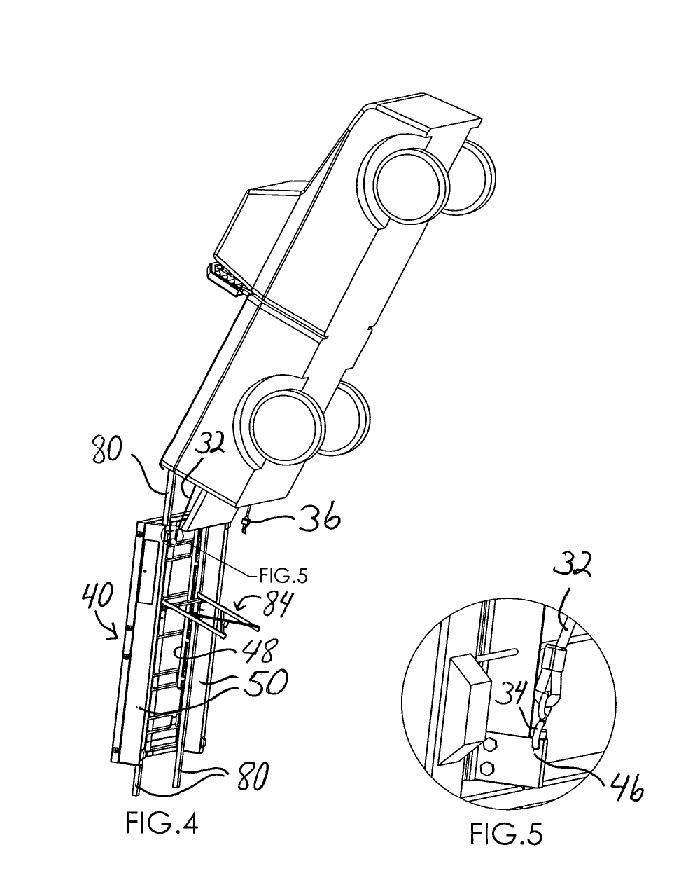

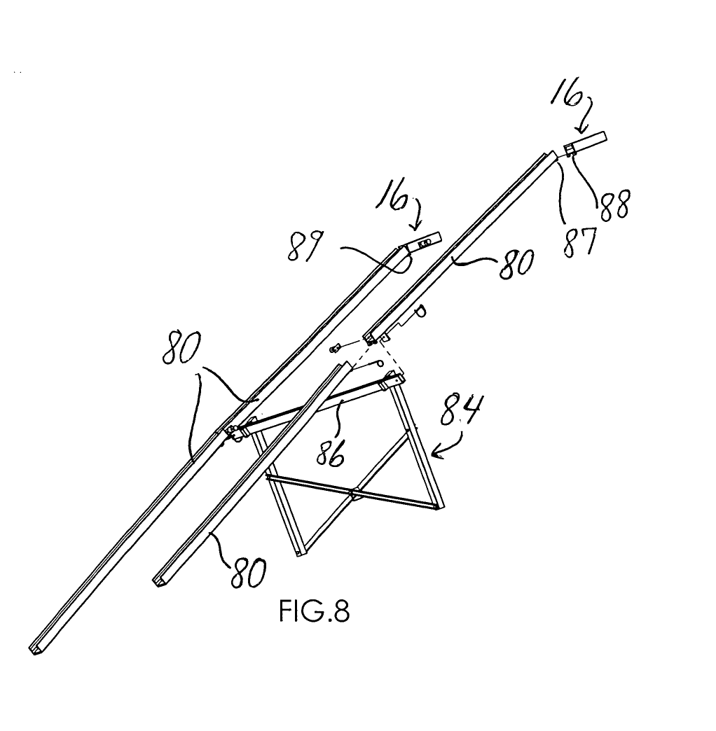

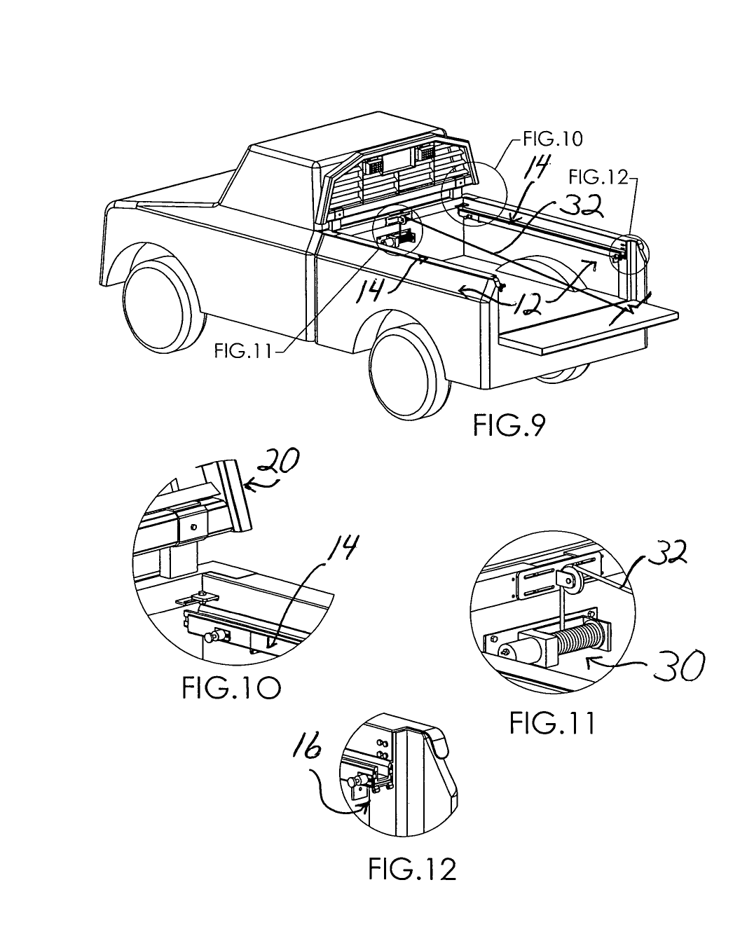

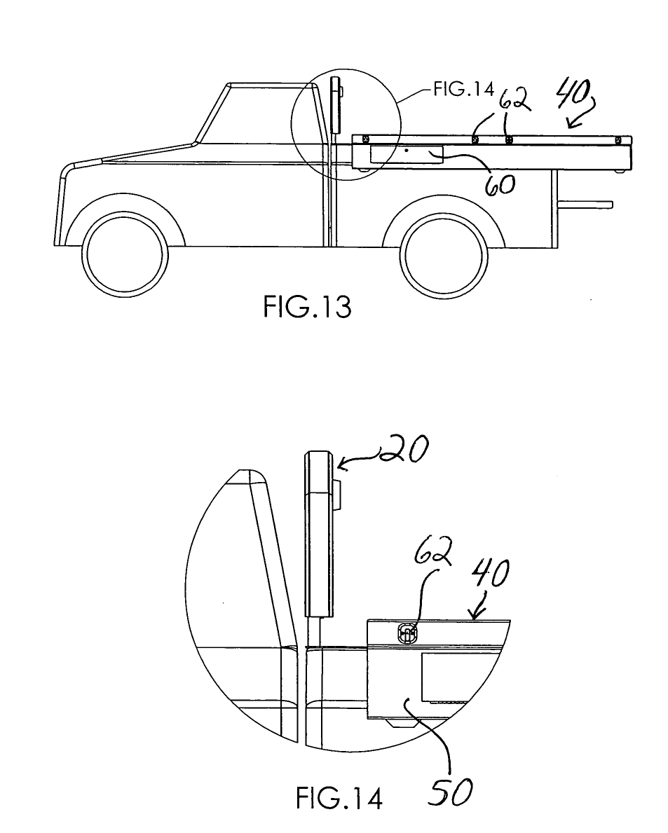

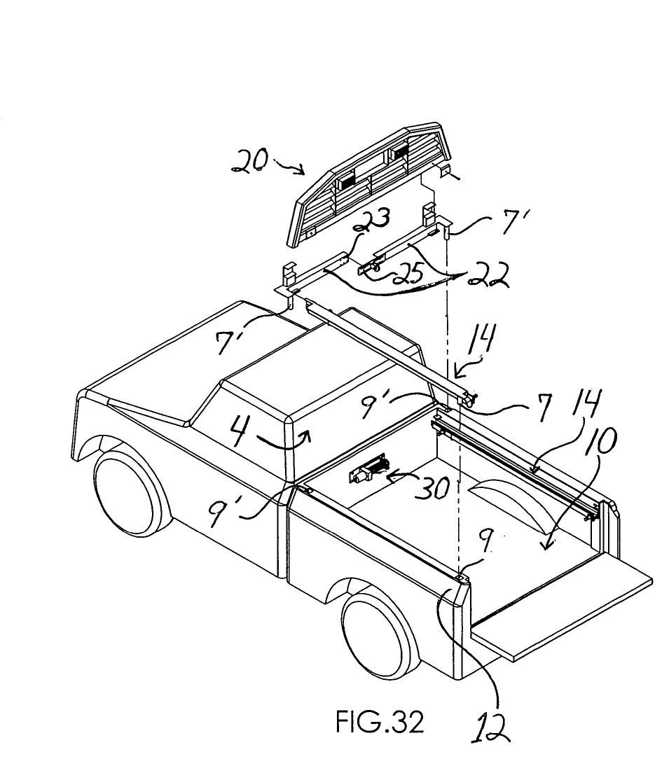

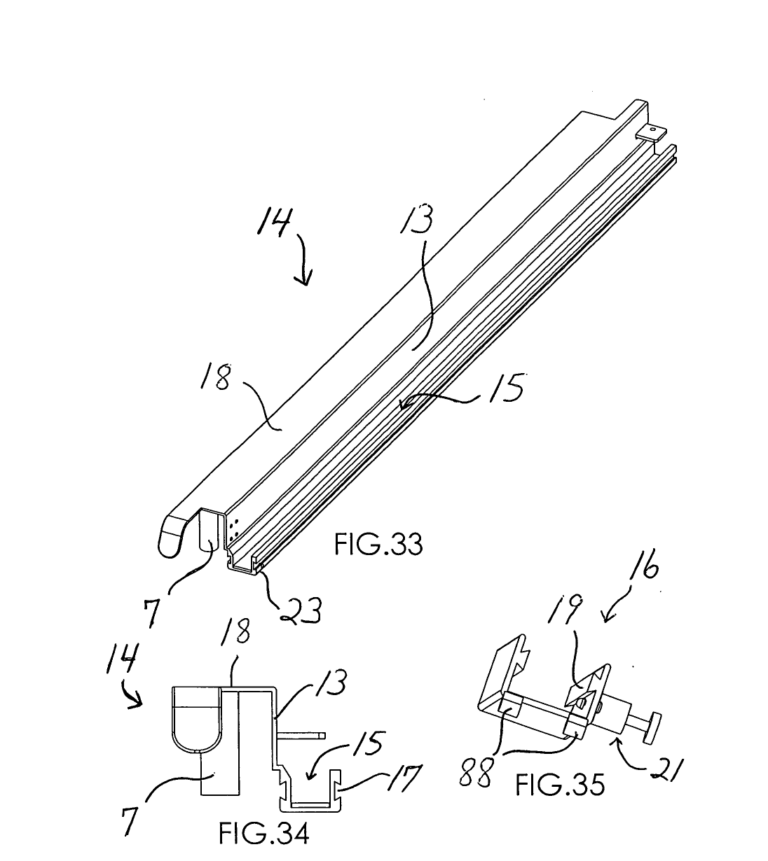

The platform system 5 is preferably retrofitted onto the bed 10 of a pickup truck 4. Tracks 14 are first installed onto the sides 12 of the bed 10. The tracks 14, shown in FIGS. 33 and 34, will receive the platform 40. The tracks 14 may be installed with bolts or other fasteners, or welded on permanently, but are preferably installed by placing a single track peg 7 into a preexisting side hole 9 on the top of the rear end of the side 12 of the bed 10 (shown in FIG. 32) and utilizing a downwardly projecting wall 13 that lies flush against the inward-facing surface of the side 12 of the bed 10. The placement of the wall 13 against the side prevents the track 14 from pivoting about the track peg 7. At the bottom edge of the wall 13 the track 14 projects in toward the center of the bed 10 and forms a channel 15 which is configured to receive a rail 48. The channel 15 will preferably be lined with ultra-high molecular weight polyurethane for lubrication. As shown in FIGS. 34 and 35, tapered grooves 17 are on the outside of the channel 15, and are configured to receive tapered projections 19 on the inside of track attachment pieces 16, forming a dovetail joint. The track attachment pieces 16 have a spring-loaded pin 21 which locks into a depression 23 near the rear end of the track 14, locking the track attachment piece 16 into place so that the track extensions 80 can connect to the track attachment pieces 16 to form a ramp on which the platform 40 slides. When the track extensions 80 are not in use, the track attachment pieces 16 are slid forward away from the rear end of the tracks 14 so that the track attachment pieces 16 will not interfere with the tailgate. This combination of components, shown in FIGS. 3-8, allows the platform 40 to slide onto the bed 10 of the truck 4 and fit securely, being able to move only longitudinally with respect to the truck 4.

As shown in FIG. 32, a cab guard 20 prevents the platform 40, or anything resting on the platform 40, from moving forward and damaging the cab of the truck 4. Two cab guard supports 22 are first installed onto the top of the front of the bed 10 in a similar manner to the tracks 14, with a cab guard support peg 7′ being inserted into a preexisting side hole 9′ on the top of the front end of the side 12 of the bed 10. One of the cab guard supports 22 has support holes 23 configured to receive bolts, while the other cab guard support 22 has a flat portion 25 extending from it with similar size holes. This combination allows the cab guard supports 22 to fit together in the middle after being placed on beds 10 of different widths. The cab guard 20 is then attached to the cab guard supports 22 by bolts or other fasteners. This securely attaches the cab guard 20 to the bed 10 of the truck 4, protecting the cab from being damaged by the platform 40 or by articles resting on the platform 40.

A winch 30 is preferably installed onto the inside surface of the front portion of the bed 10. The winch 30 utilizes a cord, preferably a cable 32, with a hook 34 that is received by a platform eye 46, as shown in FIGS. 3, 4, and 5. A switching unit 36 will allow a single person to control the cable 32, using the cable 32 to raise or assist in lowering the platform 40 onto or off of the bed 10, by either pulling the cable 32, and hence the platform 40 to which the cable 32 is attached, toward the cab of the truck 4 or the front portion of the bed 10, or loosening the cable 32 and allowing the platform 40 to move rearwardly. A winch 30 is preferred to move the platform 40, but other means could be used, such as a rope and pulley, manual crank, or purely manual. The winch 30 is also preferred to retain the platform 40 on the truck bed 10, but other means could be used, such as bolts, pins, hooks, or ties.

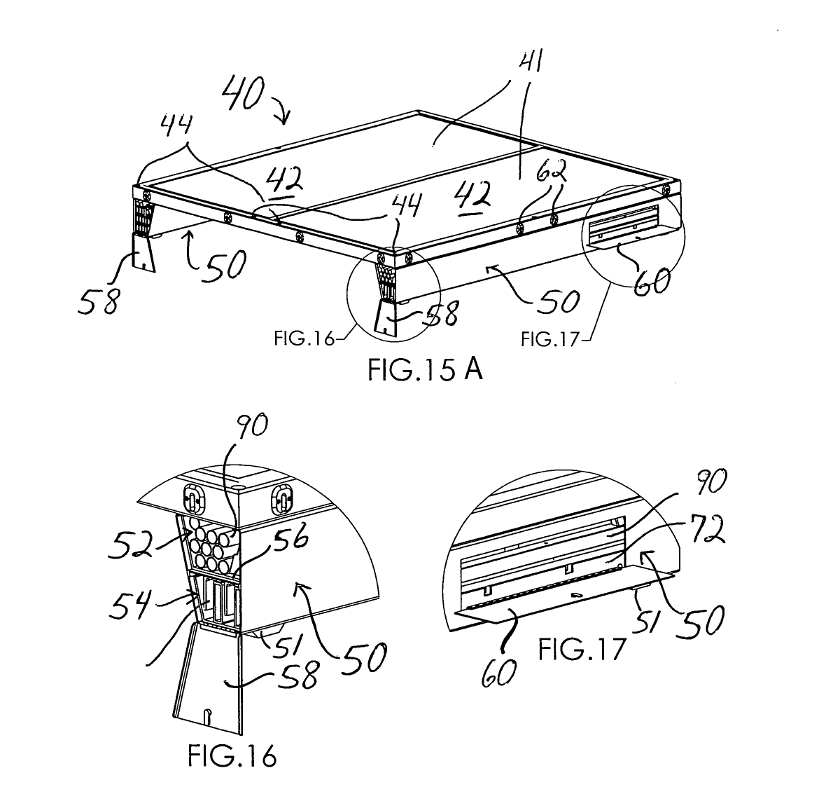

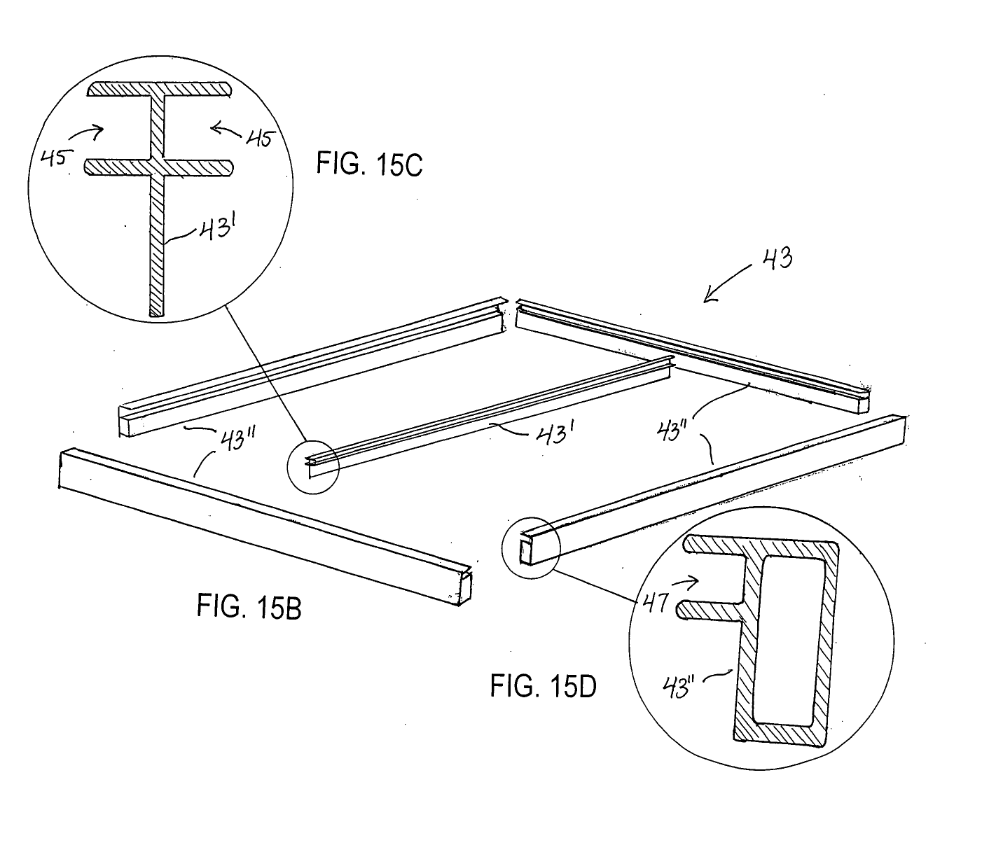

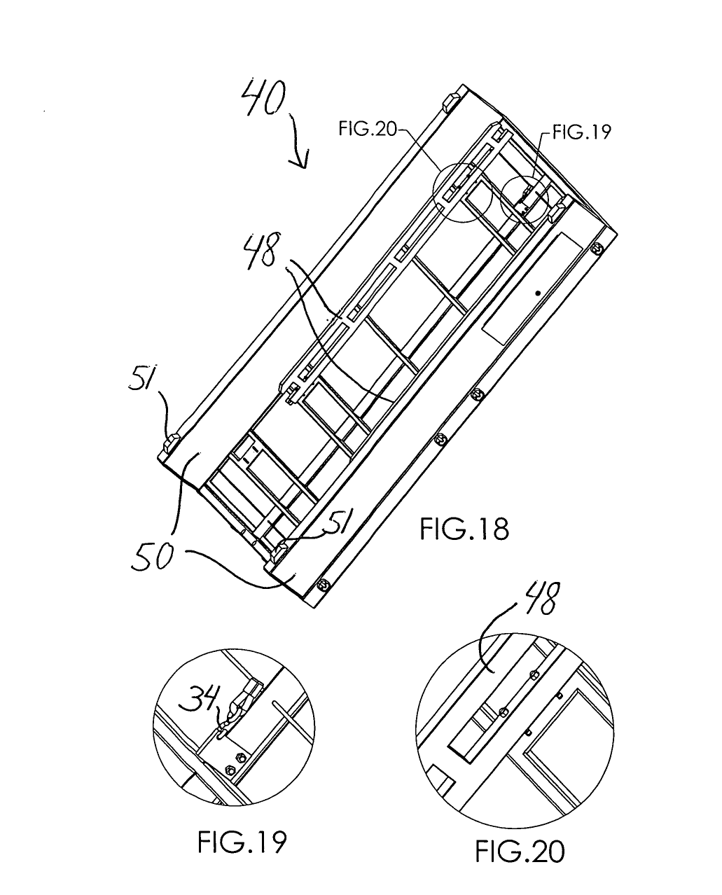

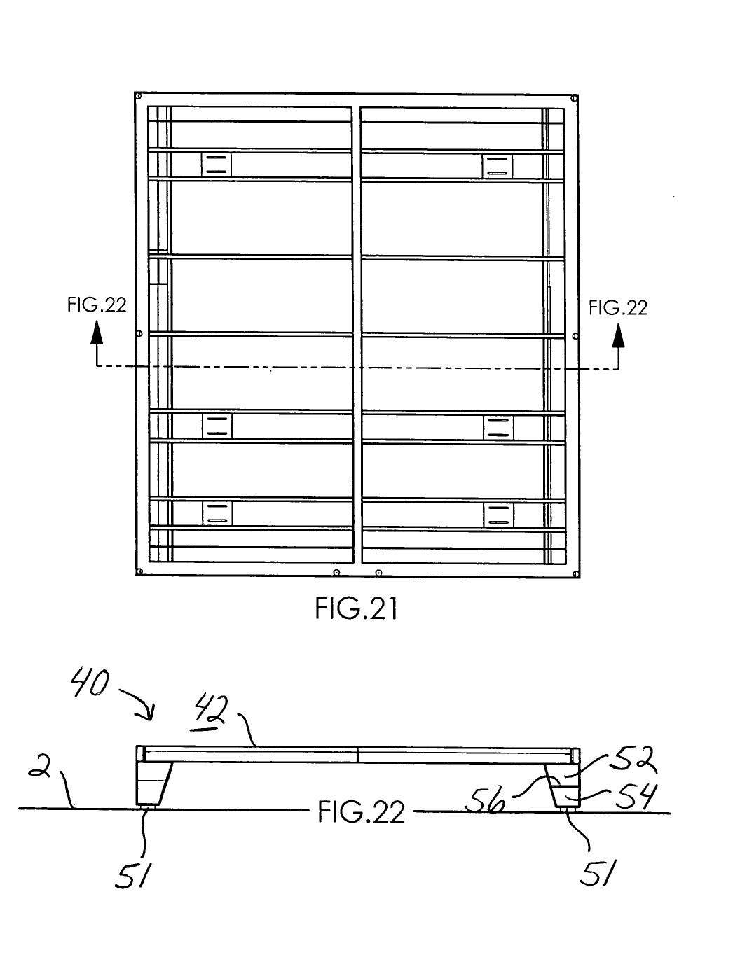

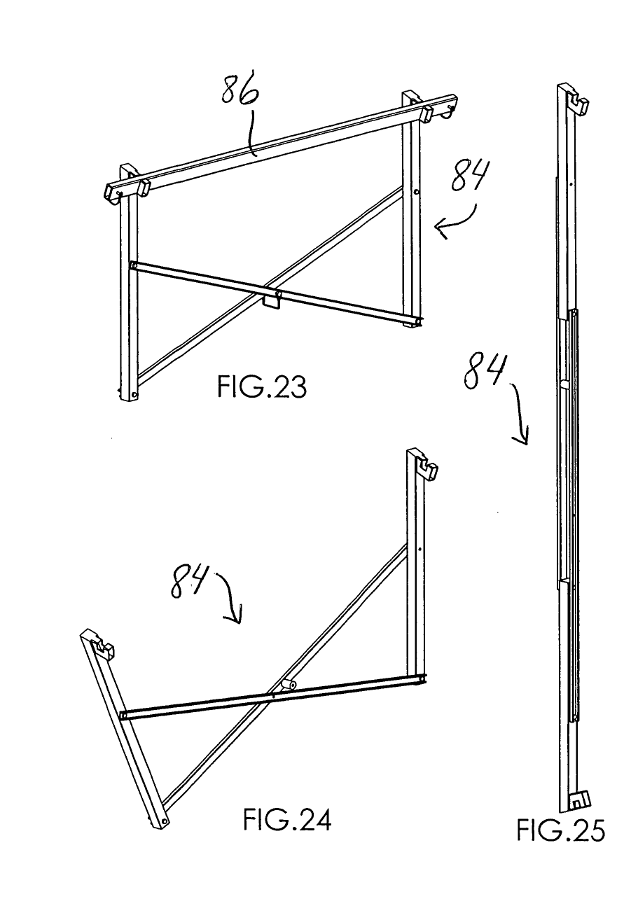

The platform 40, shown in FIGS. 15 and 18, is the core of the present invention. The top surface 42 of the platform 40 is generally flat and continuous. The platform 40 has a pair of longitudinal rails 48 which are configured to slide into the tracks 14. The rails 48 are preferably sized relative to the tracks 14 and channels 15 so that the weight of the platform 40 rests in the channels 15, and not on the tracks' tops 18 or the top surfaces of the truck bed sides 12. This prevents the platform 40 from contacting and damaging the truck bed 10. The platform 40 extends beyond the sides 12 of the truck bed 10, providing a wide surface for vehicles. The bins 50 extend down without touching the truck bed sides 12, preventing damage to the truck bed 10. The platform 40 preferably has bins 50 which extend down along opposite side edges of the platform 40. The bins 50 are preferably hollow, allowing the bins 50 to be used to store items used in the invention. The bins 50 preferably have hollow longitudinal interior spaces extending along the entire side edges of the platform 40, but these spaces should at least extend from the rear openings of the bins 50. In the preferred embodiment, the bins 50 each have a top compartment 52 and a bottom compartment 54, separated by a partition 56. The bins 50 preferably each have a rear door 58 and a side door 60, both of which may be locked and unlocked with a key. The rear doors 58 are used to insert and remove items from the bins 50, and the side doors 60 are used to access the inside of the bins 50 in case the items become stuck. The bins 50 further comprise landing pads 51 to create space between the bins 50 and the ground 2.

The platform 40 preferably comprises a frame 43 and a deck 41; the frame 43 is preferably separate from the deck 41. The frame 43 is preferably made of metal, whereas the deck 41 is preferably made of wood, plastic, or fiberglass. The frame 43 is preferably comprised of four perimeter pieces 43″ and one center piece 43′. The center piece 43′ makes the platform 40 stronger so that it can support heavier loads. The frame 43 and deck 41 are put together by first inserting the two pieces of the deck 41 into the slots 45 on either side of the center piece 43′. These slots are best shown in FIG. 15C. The perimeter pieces 43″ are then attached to the two pieces of the deck 41 by pressing the perimeter pieces 43″ onto the two pieces of the deck 41 so that the deck 41 slides into the slots 47 on the perimeter pieces 43″. The pieces of the frame 43 are then attached to each other by welding, bolts, or other fasteners. This obviates the need to use bolts or other fasteners to attach the deck 41 to the frame 43.

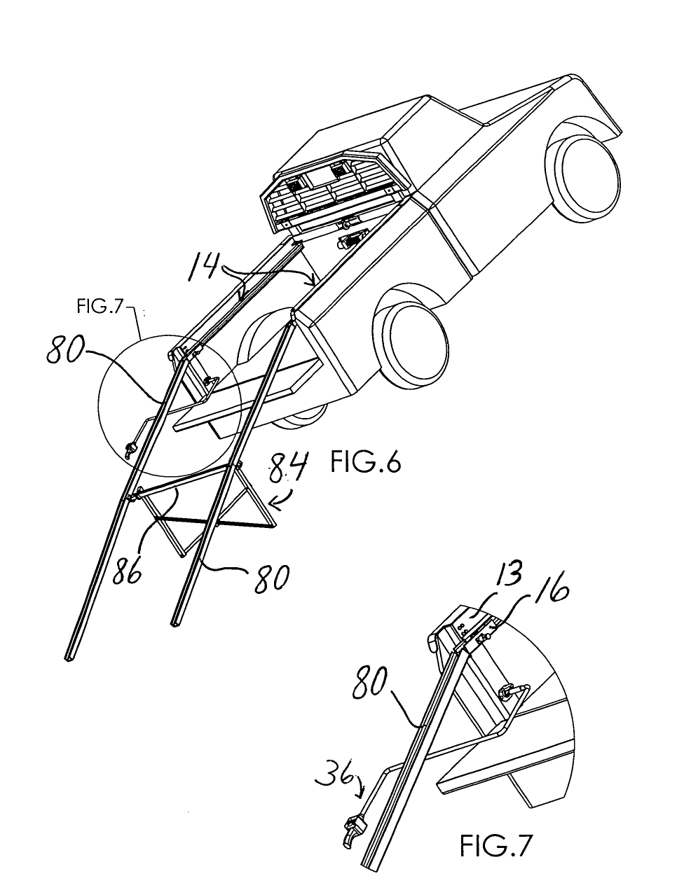

Prior to installing the platform 40 on the truck 4, a pair of track extensions 80, an intermediate support member 84, and a cross bar 86 are preferably removed from the bins 50. The “track extensions” 80 may actually be composed of more than one piece, but the term shall refer to any elongated structure capable of reaching from the ground 2 to the side 12 of the bed 10. The track attachment pieces 16 are slid back along the tracks 14 and locked into place with the spring-loaded pin at the depression 23. The track extensions 80 attach to the track attachment pieces 16 (which may be considered components of the tracks 14), preferably by apertures in tabs 87 extending from the track extensions 80 receiving hooks 88 in the track attachment pieces 16 to form pivotal connections 89. Means of disconnectable attachment or pivotal connection between the tracks 14 and track extensions 80 other than those shown in FIGS. 6 and 7 may be used, such as a pivotal hinge, a pin system, or other detachable connections, provided that protrusions do not extend into the channels 15 of the tracks 14 or into the track extensions 80 to block the platform 40 from sliding. The distal ends of the track extensions 80 abut against the ground 2, inclining the track extensions 80 at an angle to the ground 2. An intermediate support member 84 with a cross bar 86 is attached near the center of each of the track extensions 80 and also abuts against the ground, bestowing to the track extensions 80 a greater ability to support heavy loads. The track extensions 80 are shaped like the channels 15 to receive the rails 48 of the platform 40.

The platform 40 can now be installed onto the bed 10. The cable 32 is extended from the winch 30, and the hook 34 is inserted into the platform eye 46. The platform 40 is aligned along the track extensions 80. The “pull” button on the switching unit 36 is pushed, and the winch 30 pulls the platform 40 up the track extensions 80 and onto the bed 10. As the platform 40 begins to mount the bed 10, the platform rails 48 are aligned along the tracks 14 and slide into the lubricated channels 15. The fit between the rails 48 and the tracks 14 prevents lateral movement of the platform 40, and the winch 30 will pull the cable 32 taut, preventing longitudinal movement of the platform 40. The reception of the rails 48 by the channels 15 of the tracks 14 is such that the platform 40 easily slides longitudinally until the cable 32 has been pulled taut, creating a securement system consisting of the channels 15 receiving the rails 48, and the winch 30 and cord 32, holding the platform 40 in place.

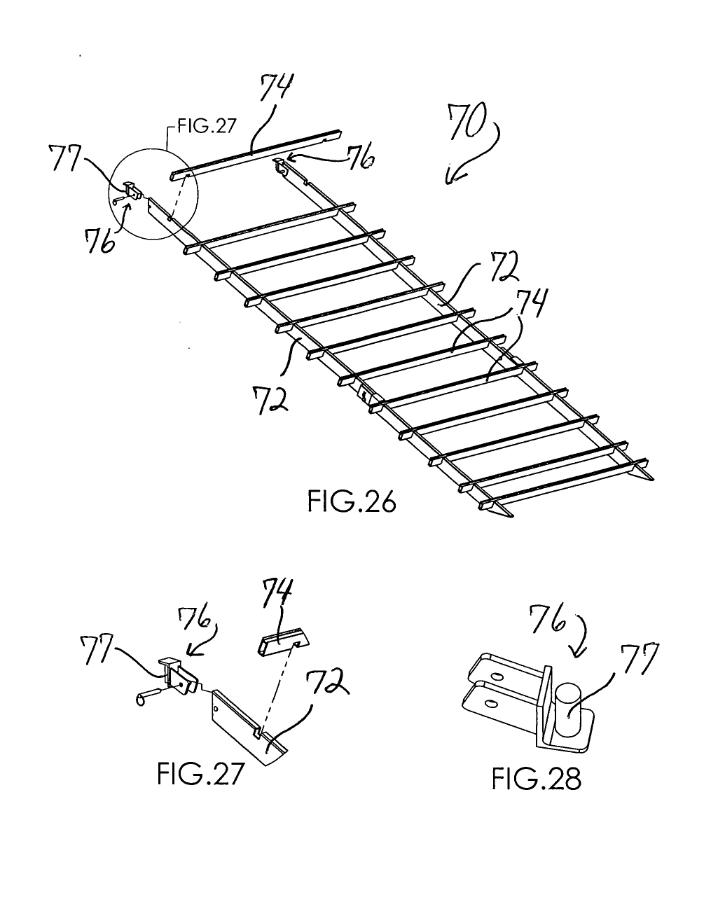

The platform 40, in its mounted position, is now in position to load the smaller vehicles. Sidepieces 72, crosspieces 74, and attachment pieces 76 are removed from the bins 50 for the purposes of creating a ladder 70. Ladder pegs 77 on the attachment pieces 76 are placed into platform holes 44 on the top of the frame 43. Platform holes 44 are located along the top of the rear and sides of the frame 43 to enable vehicles to be loaded onto the platform 40 via the ladder 70 on two different places at each side and the rear of the platform 40. At least two platform holes 44 are necessary to attach the ladder 70 to the platform 40; three platform holes 44 are necessary to enable a user to attach the ladder 70 to the platform 40 in two different places. Platform holes 44 are preferably located at the corners of the frame 43, and the middle of the side perimeter pieces 43″. This allows the sidepieces 72 of the ladder 70 to be attached onto the platform 40 with a distance between the sidepieces 72 approximately equal to half the length of the platform 40. In order to accommodate a ladder 70 wider than half the width of the platform 40 being attached to the rear of the platform 40, two platform holes 44 are set off from the center of the rear perimeter piece 43″. One sidepiece 72 would then be attached into a hole 44 in a corner of the frame 43, and the other sidepiece 72 would be attached into the hole 44 on the other side of the center of the rear perimeter piece 43″. Means of attachment between the ladder 70 and tracks 14 other than the ladder pegs 77 shown in FIGS. 26 and 28 and platform holes 44 may be used; examples of detachable connection means between the ladder 70 and tracks 14 are hooked ends, bolts, or clamps.

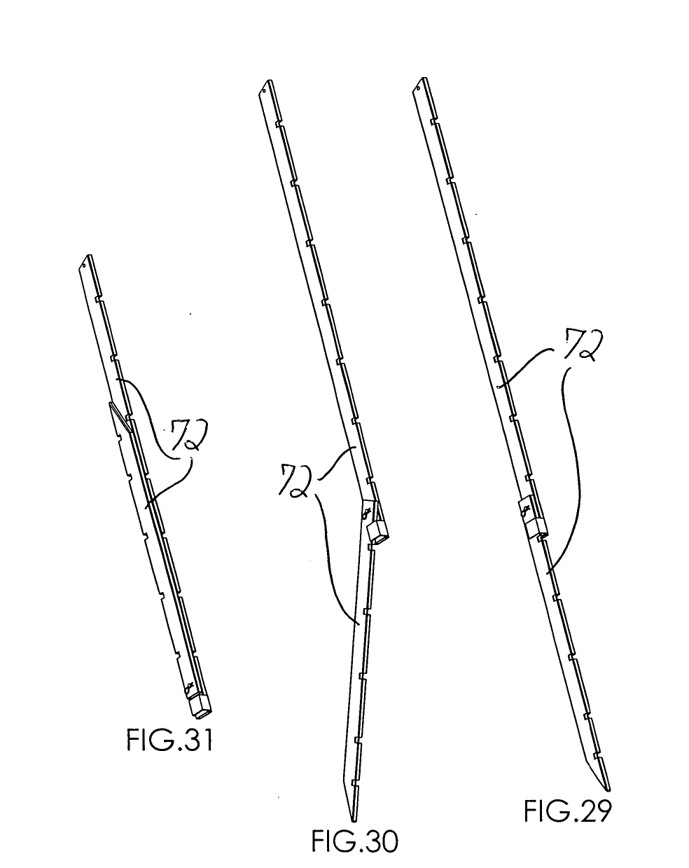

The sidepieces 72 are unfolded as shown in FIGS. 29, 30, and 31, and attached to the attachment pieces 76 (which may be considered a component of the sidepieces 72) by a pin going through apertures in both the sidepieces 72 and the attachment pieces 76, as shown in FIGS. 26 and 27. The sidepieces 72 are then spaced apart and parallel, and extend from the top of the frame 43 to the ground 2. The crosspieces 74 each have two notches, and each of the crosspiece notches is placed into one of the notches in each of the sidepieces 72, forming the ladder 70. The ladder 70 is now ready to be used to enable smaller vehicles to mount the platform 40.

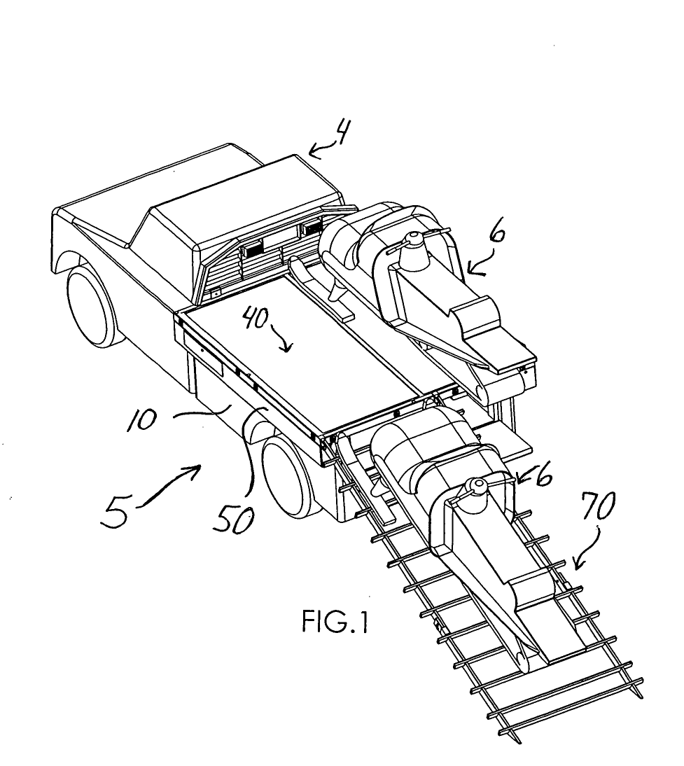

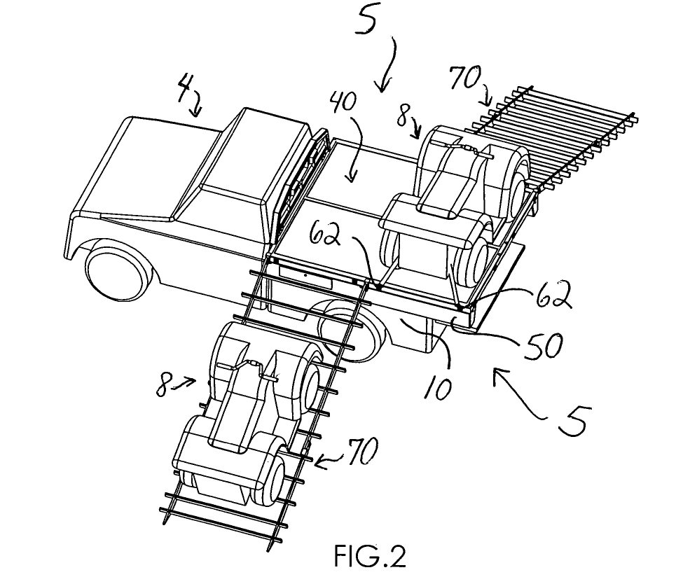

As shown in FIGS. 1 and 2, a snowmobile 6 or four-wheeler 8 is then driven up the ladder 70 and onto the platform 40. If the ladder 70 was attached to the side of the platform 40, then the ladder 70 can then be moved to an adjacent location against the platform 40 by removing all of the crosspieces 74, removing the sidepiece 72 and attachment piece 76 that is attached at the corner of the platform 40, attaching the removed sidepiece 72 and attachment piece 76 to the platform hole 44 in the other corner of the frame 43 that is adjacent to the attachment piece 76 that is still attached to the frame 43, and again placing the crosspieces 74 onto the sidepieces 72 by use of the notches. If the ladder 70 was attached to the rear end of the platform 40, then both of the sidepieces 72 must removed and replaced. This is because the width of the platform 40 dictates two platform holes 44 near the center of the rear end of the platform 40, enabling the user to attach the sidepieces 72 to the platform 40 at a distance apart greater then half the width of the platform 40; this distance should be the same as the distance between the platform hole 44 in the corner of the platform 40 and the platform hole 44 in the center of the side perimeter piece 43″. A second snowmobile 6 or four-wheeler 8 can then be driven up the ladder 70 and onto a place on the platform 40 adjacent to the first snowmobile 6 or four-wheeler 8. The sidepieces 72, crosspieces 74, and attachment pieces 76 are then removed from the platform 40 and placed back into the bins 50.

The smaller vehicles can be secured onto the platform with cords which are attached to slotted holes 62 projecting from the perimeter of the platform 40. These slotted holes 62 are preferably formed by excising holes in the frame 43 and inserting injection molded components into the excised holes. The truck 4 is then driven to and parked at the desired location. The smaller vehicles can be removed from the platform 40 and placed onto the ground 2 by removing the sidepieces 72, crosspieces 74, and attachment pieces 76 from the bins 50, attaching them to the platform 40 as described above, and driving the smaller vehicles off of the platform 40.

The platform 40 is then removed from the truck 4 and placed onto the ground 2 to form the base for a tent or campsite. The platform 40 is removed by setting up the track extensions 80 as described above, utilizing the switching unit 36 to release the tension on the cable 32 and allow slack between the winch 30 and the platform 40, and pulling the platform 40 off of the bed 10 by hand until the platform is half-way off of the bed 10. Once the platform 40 is halfway off the bed 10, the platform 40 will be pulled off of the bed 10 by gravity. The movement of the platform 40 off of the bed 10 is then controlled by the winch 30.

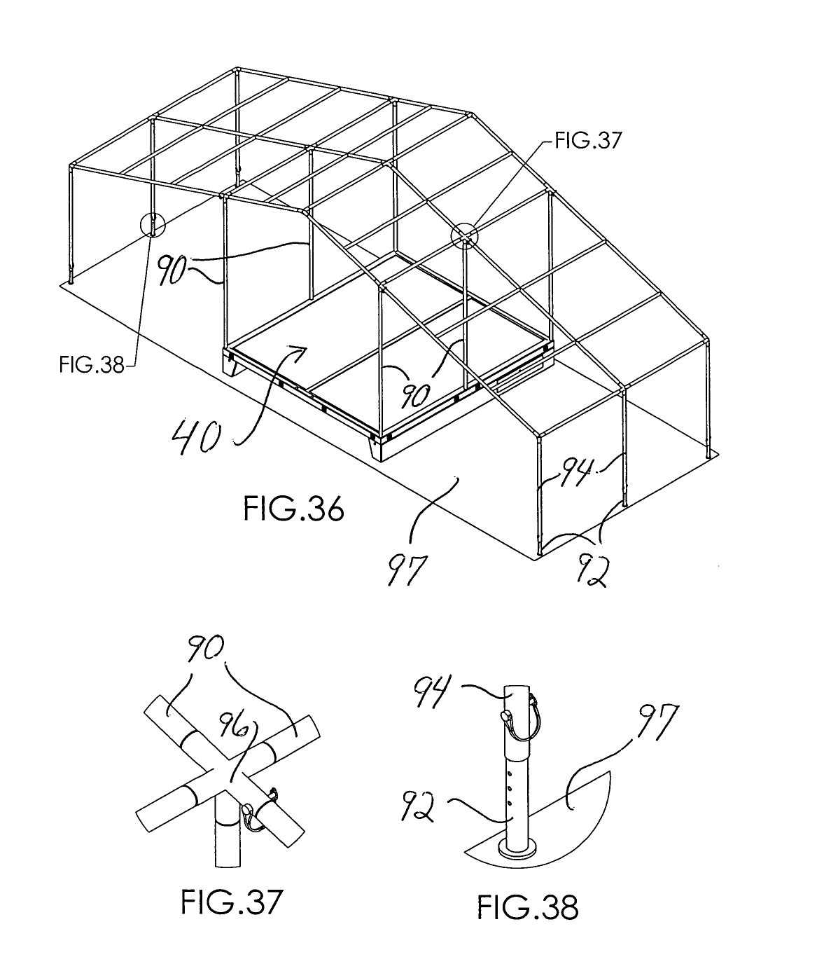

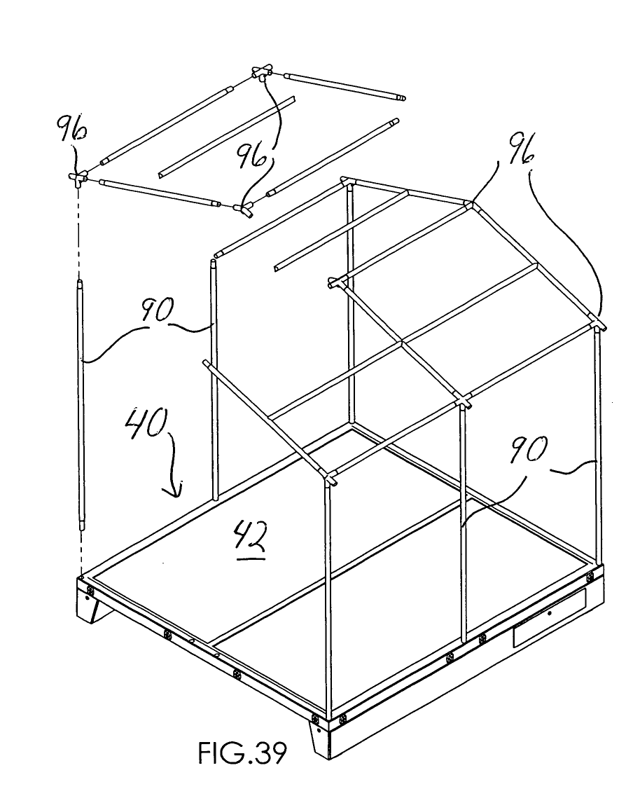

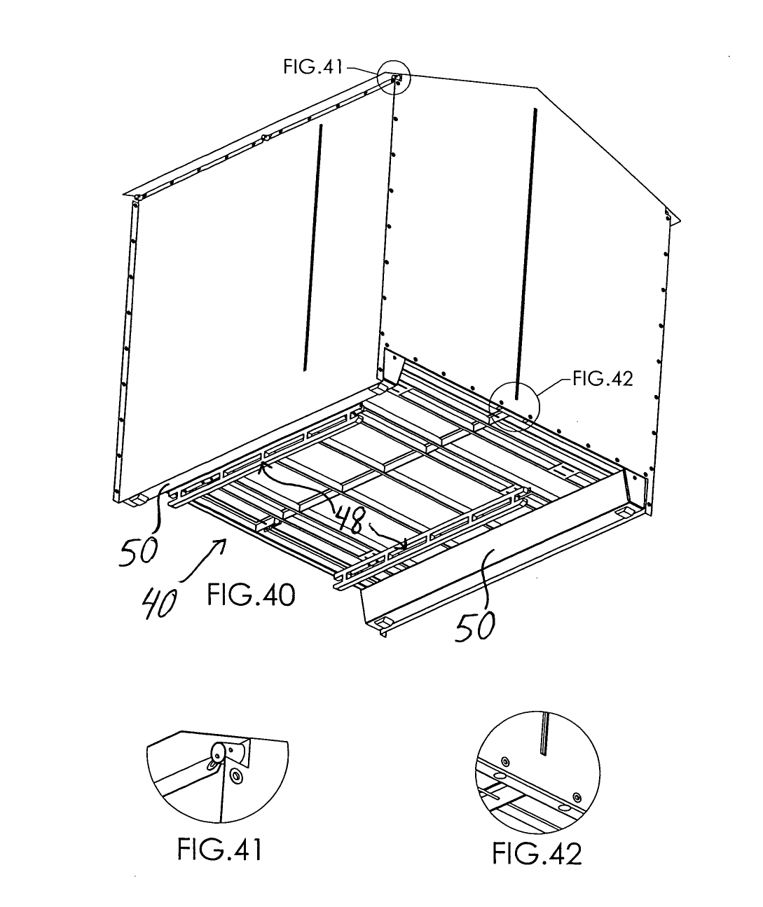

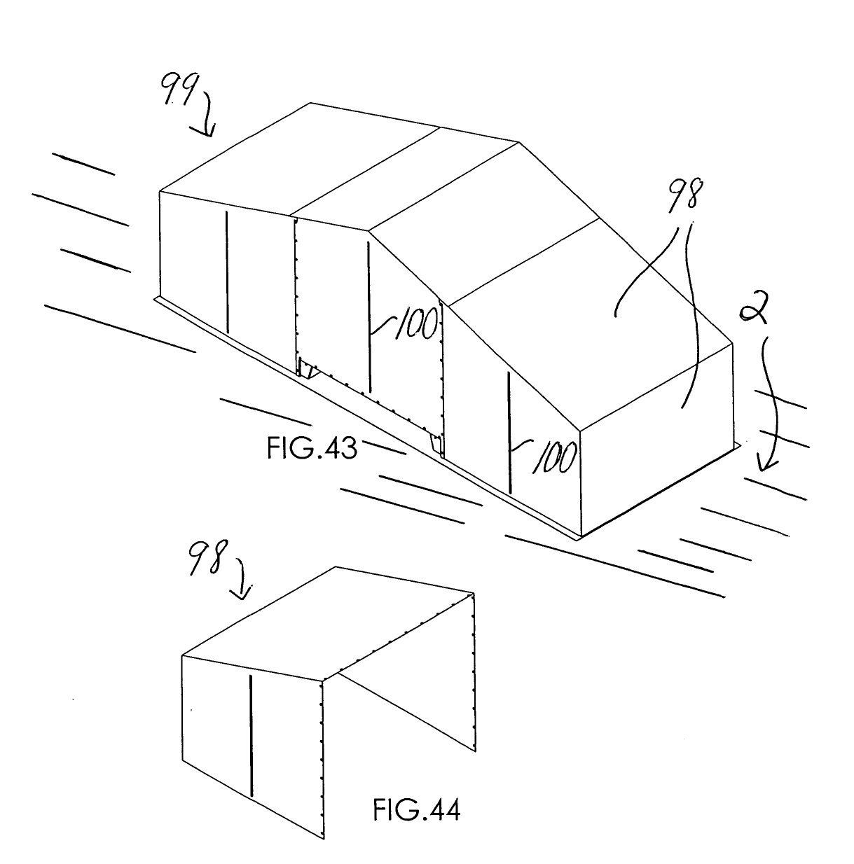

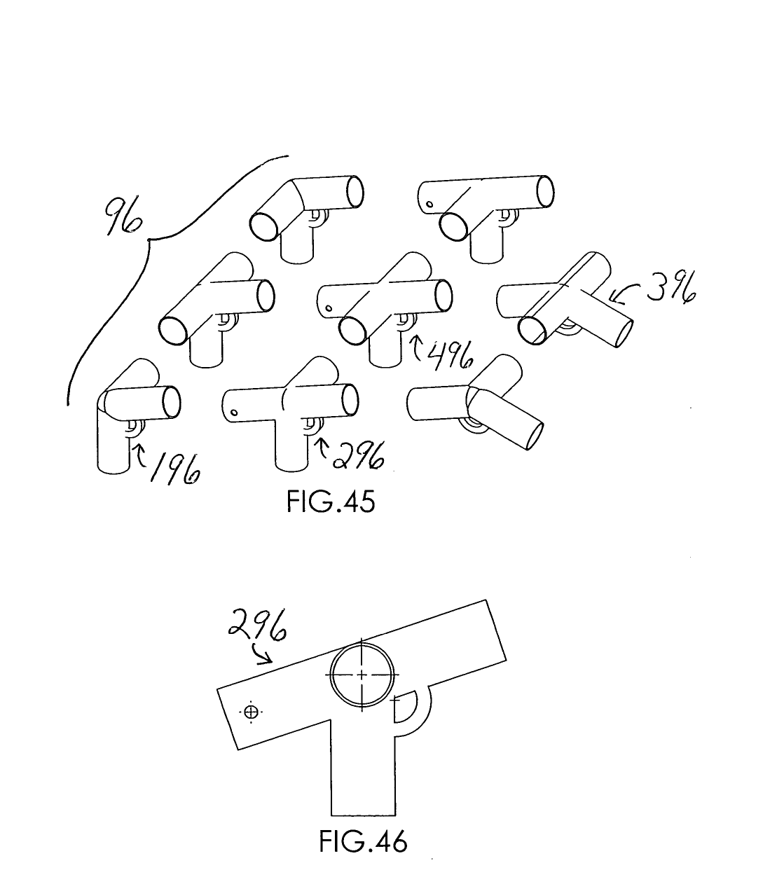

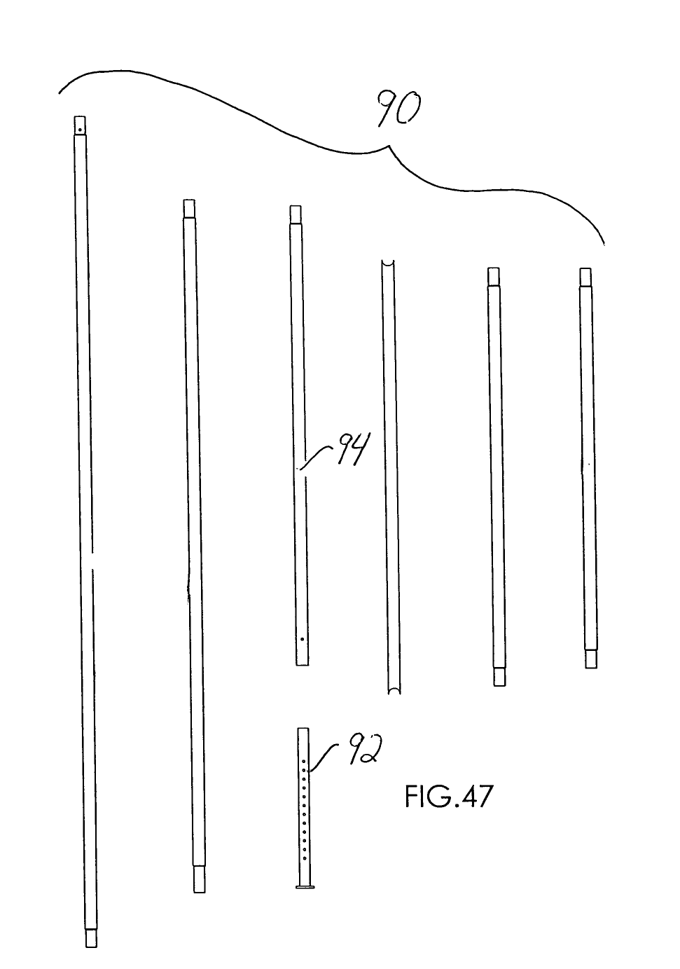

With the platform 40 in a dismounted position on the ground 2, the platform 40 is ready to be used as a base for a tent, as shown in FIGS. 36 and 39. Poles 90 are inserted into the platform holes 44, which should at least be at the four corners of the frame 43, and connectors 96 (including corner connector 196, four-way connector 296, peak connector 396, and five-way connector 496) are used to connect poles 90 above the platform 40 to form a tent structure, as shown in FIG. 39. The downward protrusion of the bins 50 from the platform 40 creates space between the platform 40 and the ground 2. This protects campers from possible flooding, and also facilitates handling the platform 40. The tent structure may be extended beyond the platform 40, as shown in FIG. 36. This is accomplished by using more poles 90 and connectors 96, as well as adjustable poles 94 and adjustable base pieces 92. The adjustable poles 94 receive the adjustable base pieces 92 and allow a user to adjust the height of the tent structure to accommodate variations in the ground 2 by putting a pin through corresponding apertures, as shown in FIG. 38. A tarp 97 other material may be used to cover the ground. All of these components are preferably stored in the bins 50.

As shown in FIG. 43, panels 98 are preferably placed over the tent structure 99 to provide shelter to campers. The panels 98 are preferably made of a light-weight, fire-retardant, water-proof material. The panels 98 preferably comprise zippers 100 to enable campers to get in and out of the tent.

The disclosed system and method enables a single person to install the platform 40 on a bed 10 of the truck 4, mount snowmobiles 6 or four-wheelers 8 on the platform 40 driving and park the truck at the desired location, removing the vehicles 6, 8 from the platform 40 remove the platform 40 from the bed 10 place the platform 40 on the ground 2, and form the tent structure.

Although this invention has been described above with reference to particular means, materials and embodiments, it is to be understood that the invention is not limited to these disclosed particulars, but extends instead to all equivalents within the scope of the following claims.

I claim:

1. An apparatus comprising:
tracks mounted on a truck bed;
track extensions connected to the tracks and reaching to or near a ground; and
a platform resting on the tracks;
wherein the platform is configured to slide along the tracks and down the track extensions from a mounted position on the truck bed to a dismounted position on the ground.

2. The apparatus of claim 1 wherein the track extensions are disconnectable from the tracks.

3. The apparatus of claim 1 wherein the track extensions are pivotally connected to the tracks.

4. The apparatus of claim 1 wherein:
the tracks comprises channels;
the platform comprises rails; and
the channels are configured to slidably receive the rails.

5. The apparatus of claim 4 further comprising:
a winch and cord configured to pull the platform toward a truck cab; and
a securement system for the platform consisting of the channels receiving the rails and the winch and cord preventing rearward movement by the platform.

6. The apparatus of claim 4 wherein:
the channels are longitudinal; and
the reception of the rails by the channels prevents lateral movement of the platform.

7. The apparatus of claim 1 wherein:
the track extensions are inclined at an angle to the ground; and
the apparatus further comprises a winch mounted near a front of the truck bed configured to pull the platform up the track extensions and onto the tracks.

8. The apparatus of claim 1 wherein:
the platform comprises hollow bins that extend down from side edges of the platform and have longitudinal interior spaces extending from rear openings of the bins.

9. An apparatus comprising:
tracks mounted on a truck bed;
track extensions connected to the tracks and reaching to or near a ground;
a platform resting on the tracks; and
a ladder connected to the platform;
wherein the platform is configured to slide along the tracks and down the track extensions from a mounted position on the truck bed to a dismounted position on the ground.

10. The apparatus of claim 9 wherein:
the ladder comprises two sidepieces with a peg at a top end of each sidepieces;
the platform comprises a top surface and at least two holes in the top surface; and
the holes receive the pegs to connect the ladder to the platform.

11. The apparatus of claim 10 wherein the platform comprises at least three holes in the top surface.

12. The apparatus of claim 11 wherein:
the platform comprises at least four holes in the top surface;
wherein the four holes are each at one of four corners on the top surface; and
the holes are configured to receive poles.

13. The apparatus of claim 12 wherein:
the platform comprises hollow bins that extend down from side edges of the platform and have longitudinal interior spaces extending from rear openings of the bins; and
the poles are stored in the bins.

14. The apparatus of claim 9 wherein the ladder comprises:
two sidepieces each comprising a plurality of first notches:
an attachment piece connected to each sidepiece, each attachment piece comprising a peg at a first end, said peg being placed into a hole in the platform; and
a plurality of crosspieces, each of said crosspieces comprising a plurality of second notches which are each placed into one of the first notches in each sidepiece.

15. A process comprising:
installing a platform on a bed of a truck;
mounting a vehicle smaller than the truck on the platform;
driving the truck;
parking the truck;
removing the vehicle from the platform;
removing the platform from the bed of the truck and placing the platform on a ground;
placing poles into holes in the platform to form a tent structure.

16. The process of claim 15 wherein:
the platform is installed on the bed of the truck by:
attaching track extensions onto tracks, said tracks being attached to the bed of the truck;
connecting a cord to the platform; and
using a winch to pull the cord and platform up the track extensions and onto the tracks.

17. The process of claim 15 wherein:
the vehicle smaller than the truck is mounted on the platform by:
attaching a ladder comprising sidepieces and crosspieces to the platform; and
driving the vehicle up the ladder and onto the platform.
